(19) United States
(12) Patent Application Publication
(10) Pub. No.: US 2007/0248174 A1
(43) Pub. Date: Oct. 25, 2007

(54) Method and System for Implementing Multiple-In-Multiple-Out Ofdm Wireless Local Area Network

(75) Inventors: Monisha Ghosh, Chappaqua, NY (US); Xuemei Ouyang, San Jose, CA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,009

(22) PCT Filed: May 10, 2005
(86) PCT No.: PCT/IB05/51529

§ 371 Date: Nov. 13, 2006

Related U.S. Application Data
(60) Provisional application No. 60/570,637, filed on May 13, 2004.
(60) Provisional application No. 60/614,726, filed on Sep. 30, 2004.

(51) Int. Cl. H04Q 11/00

(52) U.S. Cl. 375/260; 375/E01.033

(57) ABSTRACT

A method and associated systems for implementing MIMO communication systems are disclosed. The systems comprise at least one encoder (120a, 120b) for Reed-Solomon encoding a corresponding input data stream of data packets; at least one interleaver (124a, 124b) for interleaving bits of a corresponding encoded input data stream, at least one mapper (128a, 128b) for mapping the interleaved bits of a corresponding encoded input data stream, at least one inverse FFT (132a, 132b) for determining transforms of the mapped interleaved bits of a corresponding encoded bit stream, at least one cyclic prefix unit (136a, 136b) for determining a cyclic prefix of the transformed mapped interleaved bits of a corresponding encoded bit stream; and, at least one pulse shaper (140a, 140b) for shaping pulses of a corresponding encoded bit stream and means for dividing a data stream into a plurality of input data steams, the input data streams associated with a corresponding communication channel. In addition, the method provides a training sequence 700 that imposes minimal overhead on data transmission.

This application claims the benefit, pursuant to 35 USC §119(e), to that provisional patent application filed on May 13, 2004 in the United States Patent and Trademark Office, entitled “MIMO OFDM System For Wireless LAN Application,” and assigned Ser. No. 60/570,637, the contents of which are incorporated by reference herein.

This application relates to wireless communications and, more particularly, to a method and system for training a multiple-in-multiple-out (MIMO) communication system.

Wireless networking of servers, routers, access points and client devices has greatly expanded the ability of users to create and expand existing networks. In fact, wireless networks have allowed clients to connect devices such as notebook or laptop computers, Personal Digital Assistants (PDAs), and cell phones to office and home networks from remote locations not typically associated with the network. Such remote locations, referred to as hotspots, allow clients to access their own networks from local coffee shops.

To facilitate the wireless communication explosion and provide compatibility among different devices, communications protocols, such as IEEE 802.11a/b/g, have been established.

IEEE 802.11a is an important wireless local area network (WLAN) standard powered by Coded Orthogonal Frequency Division Multiplexing (COFDM). The IEEE 802.11a system can achieve transmission data rates from 6 Mbps to 54 Mbps. The current 802.11a system uses 20 MHz band as a channel at 5 GHz carrier frequency band. The entire channel is divided into 64 sub-channels and 48 of them are used to transmit information data, while the remaining 12 sub-carriers are used at the band edge for the spectrum shaping. The details of the 802.11a system sub-carrier usage and system parameters are well-known in the art.

However, these protocols are designed primarily for the transmission of data and, because of the limitations in the quantity of data transmitted, are only marginally suitable for real-time video transmission. Failure to timely deliver video data may cause errors in motion rending the images unusable, for example.

In an OFDM system, the frequency band is partitioned into frequency subchannels, referred to as carrier frequencies, each associated with a subcarrier frequency upon which data is modulated. Typically, each subchannel may experience different conditions such as fading and multipath effects, which also vary with time. Consequently, the number of bits transmitted per subchannel frequency may vary.

In order to satisfy high-volume wireless communication for applications, such as hotspots, home entertaining networks and enterprise communications, higher transmission rates are needed. A new group referred to as the IEEE 802.11n WG (Working Group), has been formed to work on a standard that can provide 100 Mbps throughput at MAC layer.

Considering the channel characteristics of Wireless Local Area Networks (WLANs), it is extremely difficult to increase the data rate with a single antenna system by merely increasing the order of the signal constellation and decoding within a reasonable SNR range. One simple method to obtain the higher transmission data rate is to use a larger channel bandwidth. This solution is simple, cheap and fast to market. However, the spectrum efficiency cannot be dramatically increased. Additional work on a 802.11a-based system is needed to reach the 3 bit/sec/Hz goal set by the standards committee.

Another way to obtain a higher data rate in a rich scattered environment is spatial multiplexing, such as the BLAST system. Different configurations of an 802.11a -based 2×2 Spatial Multiplexing Multiple-Input-Multiple-Output (SP-MIMO) systems have been investigated to find the best solution for the system's performance and complexity.

One complexity encountered in MIMO systems is the need for training each of the channels. This requires the transmission of a series of known bits from which a receiving system can estimate the effect of the transmission medium in the corresponding channel on the bit stream. As training sequences are an overhead on the transmission and do not carry user information, their inclusion in the bit stream reduces the effective rate of transmission.

Hence, there is a need in the industry for a MIMO system and a training sequence that allows the MIMO system to determine corresponding channel characteristics that impose a minimal overhead on the data transmission.

A method and systems for implementing MIMO communications are disclosed. The systems comprise at least one encoder for Reed-Solomon-encoding a corresponding input data stream of data packets; at least one interleaver for interleaving bits of a corresponding encoded input data stream; at least one mapper for mapping said interleaved bits of a corresponding encoded input data stream; at least one inverse FFT for determining transforms of said mapped interleaved bits of a corresponding encoded bit stream; at least one cyclic prefix unit for determining a cyclic prefix of the transformed, mapped interleaved bits of a corresponding encoded bit stream, and at least one pulse shaper for shaping pulses of a corresponding encoded bit stream and means for dividing a data stream into a plurality of input data streams, each input data stream associated with a corresponding communication channel. In addition, the method discloses a training sequence that imposes minimal overhead on data transmission.

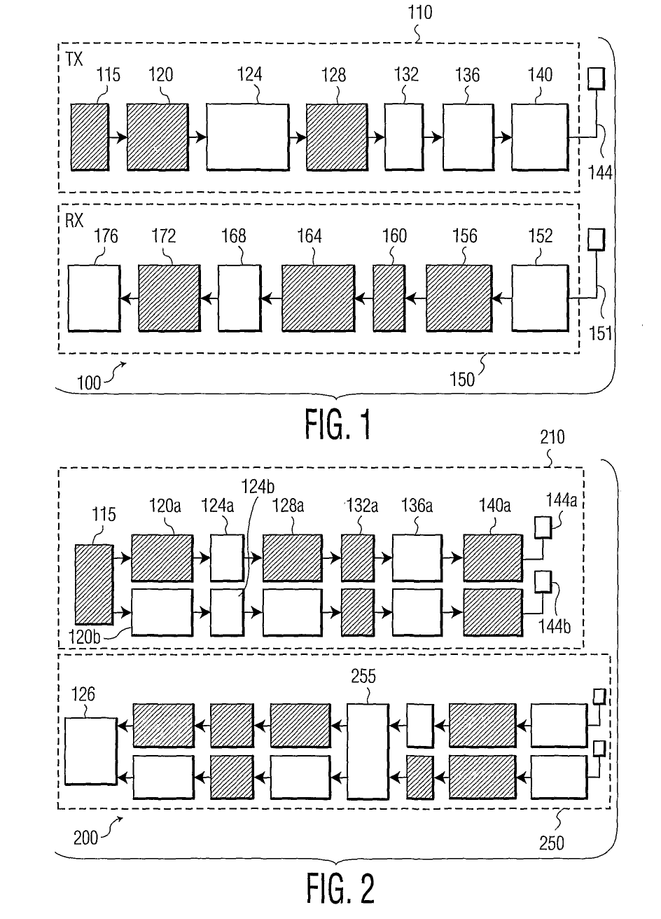

FIG. 1 illustrates a conventional wireless LAN communication system;

FIGS. 2-5 illustrate exemplary embodiments of MIMO Wireless LAN communication systems in accordance with the principles of the invention;

FIG. 6 illustrates an example of MIMO systems cross-coupling;

FIG. 7 illustrates an exemplary MIMO training sequence in accordance with the principles of the invention; and,

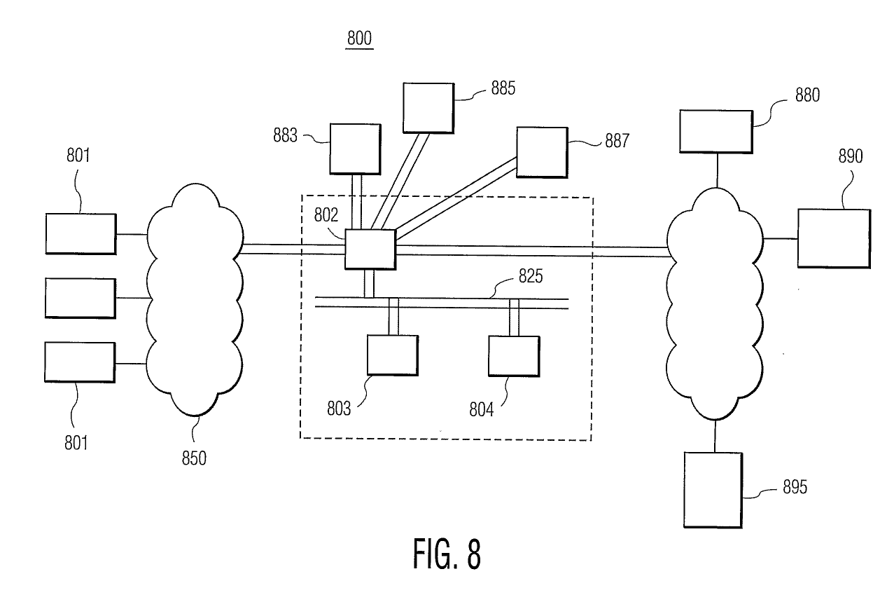

FIG. 8 illustrates a system for executing the processing shown herein.

It is to be understood that these drawings are solely for purposes of illustrating the concepts of the invention and are not intended as a definition of the limits of the invention. The embodiments shown in the figures herein and described in the accompanying detailed description are to be used as illustrative embodiments and should not be construed as the only manner of practicing the invention. Also, the same reference numerals, possibly supplemented with reference characters where appropriate, have been used to identify similar elements.

FIG. 1 illustrates a block diagram of a conventional wireless communication system 100 having a transmission section 110 and a receiving section 150. Transmission section 110 provides data 115 to forward error correction (FEC) encoder 120, which encodes data 115 in a manner to correct errors that can occur in the transmission. In one aspect, the FEC may include the well-known Reed-Soloman coding scheme. The encoded data is then applied to bit interleaver 124 and the interleaved bits are mapped in mapper 128. The encoded and interleaved bit stream is Inverse Fast Fourier Transformed in IFFT 132 and a cyclic shift of the data bits is applied in cyclic prefix 136. The bit stream is then applied to pulse shaper 140 and transmitted through the transmission media via antenna 144.

Receiving system 150 receives the transmitted bit stream at antenna 151 and reverses the transmission process by applying the received data to pulse shaper 152, sampler 156, FFT 160, de-mapper 164, de-bit interleaver 168, and FEC decoder 172 to produce output 176.

FIG. 2 illustrates one aspect of a two-channel MIMO system 200, in accordance with the principles of the invention, including transmission section 210 and receiving section 250. In this case, the data stream 115 is divided between the first channel and the second channel. In one aspect, data stream 115 may be divided such that odd bits (or bytes) are applied to the first channel and even bits (or bytes) are applied to the second channel. In this illustrated case, the components of the first and second channels are denoted with the letters “a” and “b” and are the same as those described with regard to FIG. 1. Hence, these components need not be described in detail again. The receiving section 250, operating similar to the process described with regard to FIG. 1, receives and decodes, i.e., recovers, the independently-transmitted encoded data bit streams to produce data 176. In this case, 2×2 MMSE/ZF filter 255. MMSE/ZF filtering is well known in the art as it is a standard method of decoding MIMO signals. In this illustrated embodiment, the recovered bit streams are combined after the error-correction code is removed.

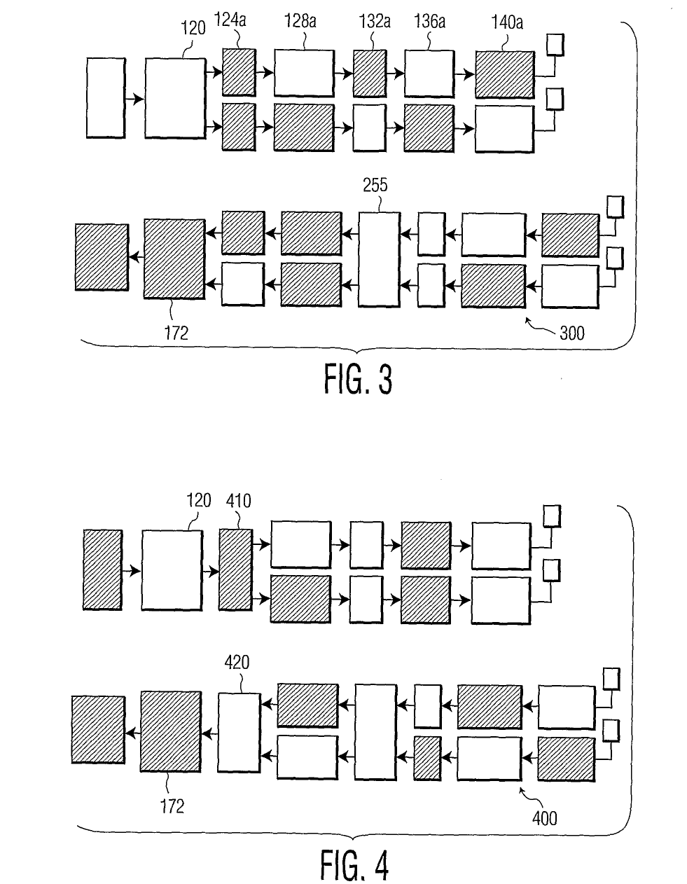

FIG. 3 illustrates a second aspect of a 2-channel MIMO system 300, in accordance with the principles of the invention. In this aspect of the invention, the data is first FEC encoded in encoder 120 and the encoded data is divided among the transmission channels as described with regard to FIG. 2. The receiving system recovers the bit streams in a process as described with regard to FIG. 2. However, in this case, the recovered bit streams are combined prior to removing the FEC in decoder 172.

FIG. 4 illustrates another aspect of a 2-channel MIMO system 400 in accordance with the principles of the invention. In this system, data 115 is FEC-encoded and interleaved in Bit-Interleaver 410 prior to dividing the bit stream among the transmission channels as described with regard to FIG. 2. In this case, the receiving section operates similar to that described with regard to FIG. 2. However, the Bit Interleaver 420 operates to bit-interleave the bit stream over all antennas jointly. This operation is different than the interleaving shown in FIG. 3, as the bit interleaver shown in FIG. 3 performs interleaving over each antenna.

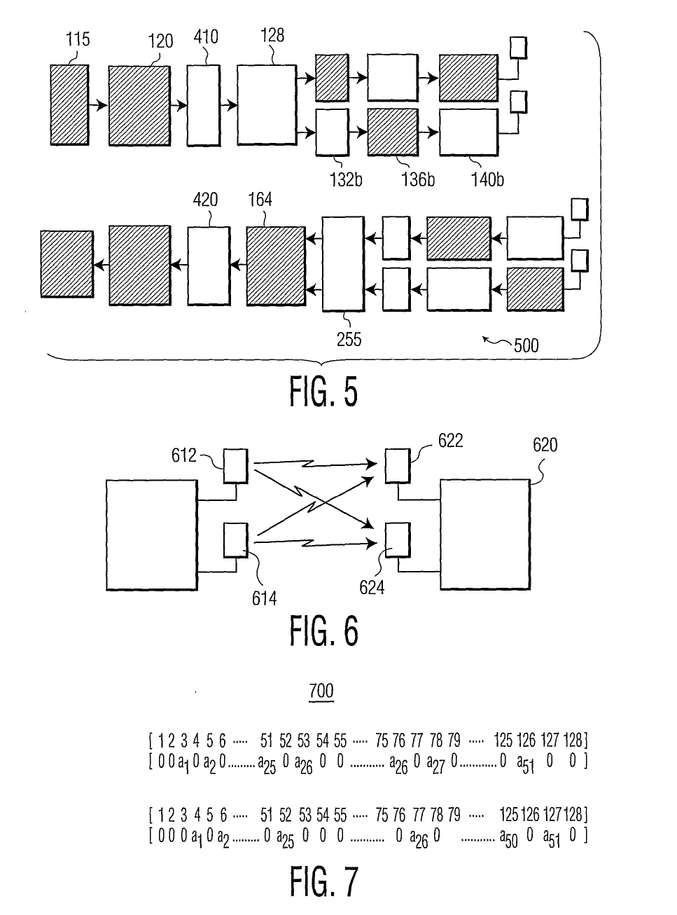

FIG. 5 illustrates still another aspect of a 2-channel MIMO system 500 in accordance with the principles of the invention. In this illustrated embodiment, data 115 is encoded by Encoder 120, interleaved by Interleaver 410, and mapped by Mapper 128 prior to dividing the data among the transmission channels. Similarly, the received data is recovered in a manner similar to that as described with regard to FIG. 4. However, in this case, the recovered bit streams are combined prior to being de-mapped by Demapper 164.

Conventional wireless communication systems operate with up to 64 frequency carriers to improve transmission by avoiding interference. In a preferred embodiment of the invention, one hundred twenty-eight (128) frequency carriers are used. In this aspect, OFDM symbols may then be grouped into blocks of 96, having 2 adjacent zero carriers at DC, 22 carriers for bandedge protection and 8 pilot carriers. The 128-block input to IFFT 132 may be formed as:
0,0, s₁, s₂ . . . s₅₂, 0, 0, . . . 0, s₅₃, s₅₄ . . . s₁₀₄, 0
where s₁ s₁₀₄, comprises the 96 data+8 pilot OFDM symbols.

In one preferred embodiment, signal transmission may appear, in the FFT domain, as:
Carrier No: [1, 2, 3 . . . 10, 11, 12 . . . 28, 29, 30 . . . 46, 47, 48 . . . 53, 54 . . . 76, 77 . . . 82, 83, 84 . . . 100, 101, 102 . . . 118, 119, 120 . . . 127, 128]
value [0, 0 d₁ . . . d₈ p₁ d . . . d₂₅ p₂ d₂₆ . . . d₄₂ p₃ d₄₃ . . . d₄₈ 0 . . . 0 d₄₉ . . . d₅₄ p₄ d₅₅ . . . d₇₁ p₅ d₇₂ . . . d₈₈ p₆ d₈₉ . . . d₉₆ 0]
where dᵢ denotes a data symbol;
pⱼ denotes a pilot symbol; and
carrier no. identifies the carrier frequency.

Thus improvement in the transmission is achieved as there are more data symbols transmitted as carrier frequencies numbered 3 through 53 and carrier frequencies numbered 77-127 are utilized for transmission. Further, carrier frequencies numbered 54 and 76, in this 128 FFT representation, are reserved for training symbols only.

FIG. 6 illustrates a block diagram of 2-channel MIMO system 600, similar to those shown in FIGS. 2-5, wherein receiving system 620 is capable of receiving the signals from a corresponding channel but also alternate channels as the transmissions occur within the same frequency band. Hence, receiving antenna 622 associated with channel 1 is capable of receiving signals from transmitting antennas 612 and 614, associated with channels 1 and 2, respectively, and receiving antenna 624 associated with channel 2 is also capable of receiving signals from transmitting antennas 612 and 614. This cross-coupling of the received signal introduces errors in the symbols recovered by receiving system 620. One means of resolving the introduced cross-coupling errors is to determine and estimate the induced error. Estimation of the errors introduced by fading, mutipath and other causes of interference is well known in the art. In conventional wireless communication systems known sequences, referred to as training sequences, have been used to provide the receiving system with sufficient information to estimate the channel characteristics, e.g., fading and multipath. However, these sequences must be sufficiently long to determine and isolate the channel characteristics from the cross-coupling interference. Including such a sufficiently long training sequence in the transmission reduces the effective bit transmission rate.

FIG. 7 illustrates an exemplary training sequence 700 for a two-channel MIMO communication system in accordance with the principles of the invention. In this exemplary sequence 700, symbols, represented as aᵢ, are transmitted on alternate carrier frequencies on the first channel and the second channel and are offset by a single adjacent, frequency carrier—for example, between the first and second channels. As shown, symbols a₁, a₂, . . . aₙ, are transmitted on the odd frequencies on the first channel and the same symbols a₁, a₂ . . . aₙ are transmitted on the even frequencies on the second channel. In this illustrated case, one hundred twenty-eight (128) carrier frequencies are used to communicate between the transmitter and the receiving system. As 51 symbols or tones are used in the sequence, symbols a₁, a₂ . . . aₙ are transmitted on carrier frequencies numbered 3 through 53 and on carrier frequencies numbered 76-126 on the first channel and on carriers 4-54 and 77-127 on the second channel. Thus, carriers 54 and 76 are reserved for training tones and no data. The sequence shown is advantageous as it enables one block of data to estimate the channel characteristics of the two channels. It would be well within the knowledge of those skilled in the art to construct similar training sequences when more than two channels are used in a MIMO communication system.

Anyone skilled in the art would recognize that the exemplary training sequence shown may be applied to systems using a different number of transmission frequencies. For example, in IEEE 802.11a/b/g systems, 64 carrier frequencies are used and, hence, the number of symbols used is changed to provide the desired isolation of training tones to specific carrier frequencies. Increasing the number of carrier frequencies from 64 to 128 requires that the phase noise between channels is significantly decreased. Hence, although the present invention is described with regard to a preferred 128 frequency system, it would be also applicable to systems with a lower number—e.g., 64, 32, etc., or a higher number—e.g., 256, 512, etc.—of carrier frequencies.

Another aspect of the invention employs a Reed-Soloman (220, 200) 20 byte-error correcting code over GF (256) using a generator polynomial represented as
x⁸+x⁴+x³+x²+1.
This generator polynomial is the same as that used in the ATSC HDTV standard. This code corrects up to 10 byte errors per 220 byte codeword. In one aspect, the packet size need not be restricted to an integral multiple of the codeword size. The RS encoder begins encoding data in blocks of 200 bytes and any leftover bytes, e.g., less than 200, are encoded as a shortened RS codeword with the same number of parity bytes (20). In one aspect, the packets may be filled with RS parity bits. For example, encoding a 100 byte packet transmitted over the 2×2 system shown above, using 128-FFT, a rate of ¾ 64 QAM modulation using a 10-byte over GF(2⁸) (220, 200) RS requires 8 bytes as pad bits. In this case, the 8 parity bytes may be used as the 8 “pad bit”-bytes; resulting in a (108, 100) code. Shortening and puncturing of RS codes is well-known in the art and need not be discussed in detail.

FIG. 8 illustrates an exemplary embodiment of a system 800 that may be used for implementing the principles of the present invention. System 800 may contain one or more input/output devices 802, processors 803 and memories 804. I/O devices 802 may access or receive information from one or more sources 801. Sources 801 may be devices such as a television system, computers, notebook computer, PDAs, cells phones or other devices suitable for receiving information to execute the processing shown herein. Devices 801 may request access over one or more network connections 850 via, for example, a wireless wide area network, a wireless metropolitan area network, a wireless local area network, a terrestrial broadcast system (Radio, TV), a satellite network, a cell phone, or a wireless telephone network, as well as portions or combinations of these and other types of networks.

Input/output devices 802, processors 803 and memories 804 may communicate over a communication medium 825. Communication medium 825 may represent, for example, a bus, a communication network, one or more internal connections of a circuit, circuit card or other apparatus, as well as portions and combinations of these and other communication media. Input data requests from the client devices 801 are processed in accordance with one or more programs that may be stored in memories 804 and executed by processors 803. Processors 803 may be any means, such as a general-purpose or a special-purpose computing system, or may be a hardware configuration, such as a laptop computer, desktop computer, a server, handheld computer, dedicated logic circuit, or integrated circuit. Processors 803 may also be Programmable Array Logic (PAL), Application Specific Integrated Circuit (ASIC), etc., which may be a hardware “programmed” to include software instructions or a code that provides a known output in response to known inputs. In one aspect, hardware circuitry may be used in place of, or in combination with, software instructions to implement the invention. The elements illustrated herein may also be implemented as discrete hardware elements that are operable to perform the operations shown using coded logical operations or by executing a hardware-executable code.

In one aspect, the principles of the present invention may be implemented by a computer-readable code executed by processor 803. The code may be stored in the memory 804 or read/downloaded from a memory medium 883, an I/O device 885 or magnetic, optical media such as a floppy disk, a CD-ROM or a DVD, 887.

Information items from device 801 received by I/O device 802 after processing in accordance with one or more software programs operable to perform the functions illustrated herein may be also transmitted over network 880 to one or more output devices represented as display 880, reporting device 890 or second processing system 895.

As one skilled in the art would recognize, the term computer or computer system may represent one or more processing units in communication with one or more memory units and other devices, e.g., peripherals, connected electronically to and communicating with at least one processing unit. Furthermore, the devices may be electronically connected to the one or more processing units via internal buses, e.g., ISA bus, microchannel bus, PCI bus, PCMCIA bus, etc., or one or more internal connections of a circuit, circuit card or other device, as well as portions and combinations of these and other communication media or an external network—e.g., the Internet and Intranet.

In the current IEEE 802.11a/g standard, a 64-point FFT is used to form the transmitted signal. In this case, the cyclic prefix, which is inserted to protect against a multipath, is 16 samples long, and, thus leads to an overhead of 25%. This large overhead limits the user data rate, even if one were to use a MIMO system. Moreover, the channel estimation for MIMO systems suffers when a 64-point FFT used as a frequency interleaved training sequence allows each antenna only a small number of frequency bins for channel estimation. Hence, the present invention preferably employs a 128-point FFT system that allows for a greater number of entries per bin and further reduces the overhead due to the cyclic prefix. In conjunction with the frequency interleaved training sequence used for channel estimation described herein, there is very little loss of performance compared to a 64-point FFT system.

While there has been shown, described, and noted fundamentally novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. For example, while the present invention has been described with regard to a two-channel MIMO, it would be within the skill of those practicing the art to expand the concept shown herein to a system with more channels. It is expressly intended that all combinations of those elements that perform substantially the same function in substantially the same way to achieve the same results are within the scope of the invention. Substitutions of elements from one described embodiment to another are also fully intended and contemplated.

What is claimed is:

1. A method for providing a training sequence in a multiple-in-multiple-out (MIMO) wireless communication system (200), said method comprising the steps of:
transmitting a symbol selected from a plurality of data symbols and training symbols on selected carrier frequency of a first channel; and
transmitting said symbol on a selected carrier frequency of a second channel, said second channel selected carrier frequency being offset from the first channel selected carrier frequency.

2. The method as recited in claim 1, wherein said training symbols are predetermined.

3. The method as recited in claim 1, wherein said symbol transmitted on a selected one of said first channel carrier frequencies (700.51a) is transmitted on an adjacent second channel carrier frequency (700.52b).

4. The method as recited in claim 1, wherein a predetermined number of adjacent first channel carrier frequencies (700.1a, 700.1b) transmit no symbols.

5. The method as recited in claim 1, wherein said symbols are transmitted on alternate first channel carrier frequencies (700.76a, 700.78a).

6. The method as recited in claim 1, wherein at least two channel frequencies are reserved for said training symbols and not used for data symbol transmission.

7. The method as recited in claim 6, wherein said at least two channel frequencies are located substantially near a spectrum bandedge (700.1a, 700.1b).

8. An apparatus for transmitting a training sequence in a multiple-in-multiple-out (MIMO) wireless communication system, said system comprising:
a processor in communication with a memory, said processor executing a code for:
transmitting a symbol selected from a plurality of data symbols and training symbols on selected carrier frequencies of a first channel; and
transmitting said symbol on a selected carrier frequency of a second channel, said second channel selected carrier frequency being offset from the first channel selected carrier frequency.

9. The apparatus as recited in claim 8, wherein said training symbols are predetermined.

10. The apparatus as recited in claim 8, wherein a symbol transmitted on a selected one of said first channel carrier frequencies is transmitted on an adjacent second channel carrier frequency.

11. The apparatus as recited in claim 8, wherein a number of carrier frequencies are selected from the group consisting of: 32, 64, 128, 256 and 512.

12. The apparatus as recited in claim 8, a predetermined number of adjacent ones of said first channel carrier frequencies transmit no data symbols.

13. The apparatus as recited in claim 8, wherein said symbols are transmitted on alternate first channel carrier frequencies.

14. The apparatus as recited in claim 8, further comprising:
an input/output device in communication with said processor.

15. The apparatus as recited in claim 8, further comprising:
a transmitting unit.

16. The apparatus as recited in claim 8, wherein at least two first channel carrier frequencies are reserved for training symbols and not used for data symbol transmission.

17. The apparatus as recited in claim 16, wherein said at least two first channel carrier frequencies are positioned substantially near a spectrum bandedge.

18. A MIMO wireless communication transmitting system (210) for transmitting a data stream via a plurality of communication channels (144a, 144b) in a plurality of data packets, said system comprising:
at least one encoder (120a, 120b) for Reed-Solomon encoding a corresponding input data stream of data packets;
at least one interleaver (124a, 124b) for interleaving bits of a corresponding encoded input data stream;
at least one mapper (128a, 128b) for mapping said interleaved bits of a corresponding encoded input data stream;
at least one inverse FFT (132a, 132b) for determining transforms of said mapped interleaved bits of a corresponding encoded bit stream;
at least one cyclic prefix unit (136a, 136b) for determining a cyclic prefix of said transformed, mapped interleaved bits of a corresponding encoded bit stream; and,
at least one pulse shaper (140a, 140b) for shaping pulses of a corresponding encoded bit stream.

19. The system as recited in claim 18, further comprising:
means for dividing said data stream (115) into a plurality of input data steams, said input data streams associated with a corresponding communication channel.

20. The system as recited in claim 19, wherein said dividing means is imposed prior to an element selected from the group consisting of the: encoder, interleaver, mapper, inverse FFT, cyclic prefix and pulse shaper.

21. The system as recited in claim 20, wherein each of said plurality of communication channels operates on a number of carrier frequencies selected from the group consisting of: 32, 64, 128, 256 and 512.

22. The system as recited in claim 18, further comprising:
processor means for:
transmitting a symbol selected from a plurality of data symbols and training symbols on selected carrier frequencies on a first channel (700.1.1-700.1.128); and,
transmitting said symbol on a selected carrier frequency on a subsequent channel (700.2.1-700.2.128), said subsequent channel selected carrier frequency being offset from the first channel selected carrier frequency.

23. The system as recited in claim 22, wherein said subsequent channel carrier frequency is frequency adjacent to said first channel selected carrier frequency.

24. The system as recited in claim 22, wherein a predetermined number of adjacent ones of said first channel carrier frequencies transmit no data symbols.

25. The system as recited in claim 22, wherein said symbols are transmitted on alternate ones of said first channel carrier frequencies (700.1.n, 700.1.n+2).

26. The system as recited in claim 18, wherein unfilled data packets are filled with Reed-Solomon parity bits.

27. A computer readable medium containing code thereon for use in a multiple-in-multiple-out (MIMO) wireless communication system, said code for:
transmitting a symbol selected from a plurality of data symbols and training symbols on selected carrier frequencies of a first channel; and
transmitting said symbol on a selected carrier frequency of a second channel, said second channel selected carrier frequency being offset from the first channel selected carrier frequency.

28. The computer readable medium as recited in claim 27, wherein said training symbols are predetermined.

29. The computer readable medium as recited in claim 27, said code further for:
transmitting a symbol on a selected one of said first channel carrier frequencies; and
transmitting said symbol on an adjacent second channel carrier frequency.

30. The computer readable medium as recited in claim 27, wherein a number of carrier frequencies are selected from the group consisting of: 32, 64, 128, 256 and 512.

31. The computer readable medium as recited in claim 27, said code further for:
transmitting no data systems on a predetermined number of adjacent ones of said first channel carrier frequencies.

32. The computer readable medium as recited in claim 27, said code further for:
transmitting said symbols on alternate first channel carrier frequencies.

33. The computer readable medium as recited in claim 27, said coder further for:
reserving at least two first channel carrier frequencies for training symbols and not used for data symbol transmission.

34. The computer readable medium as recited in claim 33, wherein said at least two first channel carrier frequencies are positioned substantially near a spectrum bandedge.
